(19) United States
(12) Patent Application Publication
(10) Pub. No.: US 2006/0117939 A1
(43) Pub. Date: Jun. 8, 2006

(54) Integrated computer and music keyboard module

(76) Inventor: Lai-Chen Lai, Yonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/128,276

(22) Filed: May 13, 2005

(30) Foreign Application Priority Data
Dec. 6, 2004 (TW) 93137667

(51) Int. Cl. G10H 1/32; G10H 3/00

(52) U.S. Cl. 84/744

(57) ABSTRACT

An integrated computer and music keyboard module includes a key assembled base, on a first side of which a plurality of music keys are parallelly arranged. The key assembled base is provided on at least one lateral end with a connecting member for turnably connecting at least one extended module thereto. The extended module includes an extended key assembled base, on a first side of which a plurality of music keys are arranged, and on a second side of which a plurality of computer keys are arranged. When the extended module is turned about the connecting member to an extended position, a music keyboard is shown; and when the extended module is turned to a folded position, the computer keys are exposed to serve as a computer keyboard.

### FIELD OF THE INVENTION

The present invention relates to an integrated computer and music keyboard module, and more particularly to an integrated computer and music keyboard module that normally serves as a keyboard of a computer and could be extended to present a music keyboard for playing or composing music on the computer.

### BACKGROUND OF THE INVENTION

A keyboard is an important input device for a computer. All data, including numerics, characters, control instructions, etc., are input to the computer via the keyboard. A desktop computer generally includes a keyboard configured as a separate module, which is connected to a keyboard connecting port on the computer case of the computer via a cable having a connector provided thereon. Currently, there is also developed a keyboard for wirelessly connecting to the host of the computer using the wireless transmission technique.

For a notebook computer, the keyboard is normally fitted on the computer case of the notebook computer for a user to input numerics, characters, and/or control instructions to the computer.

In recent years, audio-visual equipment has been integrated into the computer, enabling the computer to serve as a multimedia player. A lover of music may purchase a separate music keyboard and connect the same to the computer, so as to play or compose music on the computer using relevant applications for such purposes.

While the computer may be provided with the function of multi-media player by connecting a music keyboard thereto, the user has to additionally purchase the separate music keyboard, and the music keyboard and the original computer keyboard are two completely separate input devices. For the users of notebook computers, it is not only uneconomical to expend extra money to purchase the additional music keyboard, but also very troublesome to manage or carry two different input devices.

In a further analysis of key type and function of the computer and music keyboards, it is found signals generated via depressing of keys on the two types of keyboards all are processed in a simple way and then sent to the computer, though the two types of keyboards have different key arrangements. Thus, it would be a great convenience to users if the computer and the music keyboard were integrated into one single input module.

### SUMMARY OF THE INVENTION

A primary object of the present invention is to provide an integrated computer and music keyboard module in which a keyboard generally equipped with a computer and a general music keyboard are included.

Another object of the present invention is to provide an integrated computer and music keyboard module that is foldable. When the keyboard module is in a completely folded state, it serves as a standard computer keyboard for a user to input different data, including numerics, characters, control instructions, etc., to a computer connected therewith; and when the keyboard module is in a completely extended state, it serves as a music keyboard for a user to play or compose music on the computer using relevant applications.

To achieve the above objectives, in accordance with the present invention, an integrated computer and music keyboard module includes a key assembled base, on a first side of which a plurality of music keys are parallelly arranged. The key assembled base is provided on at least one lateral end with a connecting member for turnably connecting at least one extended module thereto. The extended module includes an extended key assembled base, on a first side of which a plurality of music keys are arranged, and on a second side of which a plurality of computer keys are arranged. When the extended module is turned about the connecting member to an extended position, a music keyboard is shown; and when the extended module is turned to a folded position, the computer keys are exposed to serve as a computer keyboard.

With the integrated computer and music keyboard module of the present invention, a user may selectively extend or fold the keyboard module depending on actual need. The integrated keyboard module serves as a music keyboard when it is extended, and a computer keyboard when it is folded. The user may save the money that is otherwise expended to additionally purchase a separate music keyboard, and the integrated keyboard module is more convenient for carrying, particularly to a user of notebook computer.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a notebook computer equipped with an integrated computer and music keyboard module according to a first embodiment of the present invention;

FIG. 2 is a perspective view showing the integrated computer and music keyboard module on the notebook computer of FIG. 1 is extended to show the music keyboard thereof;

FIG. 3 is a sectional view taken along line 3-3 of FIG. 2;

FIG. 4 is a perspective view showing the integrated computer and music keyboard module mounted on the notebook computer of FIG. 1 is foldable to show the computer keyboard thereof;

FIG. 5 is a perspective view showing the use of the music keyboard of the integrated computer and music keyboard module of the present invention to play music;

FIG. 6 is a perspective view showing the use of the music keyboard of the integrated computer and music keyboard module of the present invention to compose music on a computer;

FIG. 7 is a perspective view of an integrated computer and music keyboard module according to a second embodiment of the present invention mounted on a notebook computer, wherein a plurality of parallelly arranged music keys are presented on the computer case of the notebook computer;

FIG. 8 is another perspective view of the integrated computer and music keyboard module according to the second embodiment of the present invention mounted on the notebook computer of FIG. 7, wherein a plurality of parallelly arranged computer keys are presented on the computer case of the notebook computer;

FIG. 9 is perspective view of an integrated computer and music keyboard module according to a third embodiment of the present invention;

FIG. 10 is a perspective view of the integrated computer and music keyboard module of FIG. 9 in a fully extended state; and

FIG. 11 is a sectional view taken along line 11-11 of FIG. 10.

### DETAILED DESCRIPTION OF THE PREFERRED EMBODIMENTS

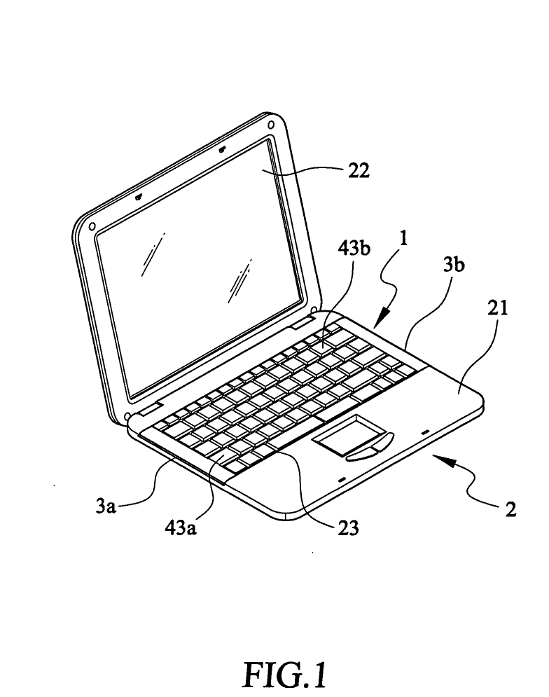

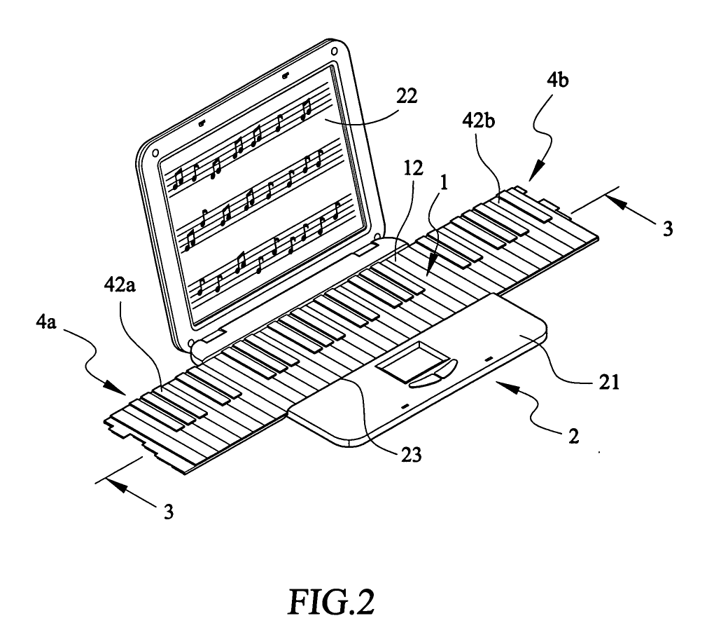

Please refer to FIG. 1 that is a perspective view of a notebook computer 2 equipped with an integrated computer and music keyboard module 1 according to a first embodiment of the present invention, and to FIG. 2 that shows the integrated computer and music keyboard module 1 on the notebook computer 2 of FIG. 1 is extended to show a music keyboard thereof. As shown, the notebook computer 2 includes a computer case 21 and a display screen 22. The integrated computer and music keyboard module 1 of the present invention is firmly fitted in a recess 23 provided on the computer case 21.

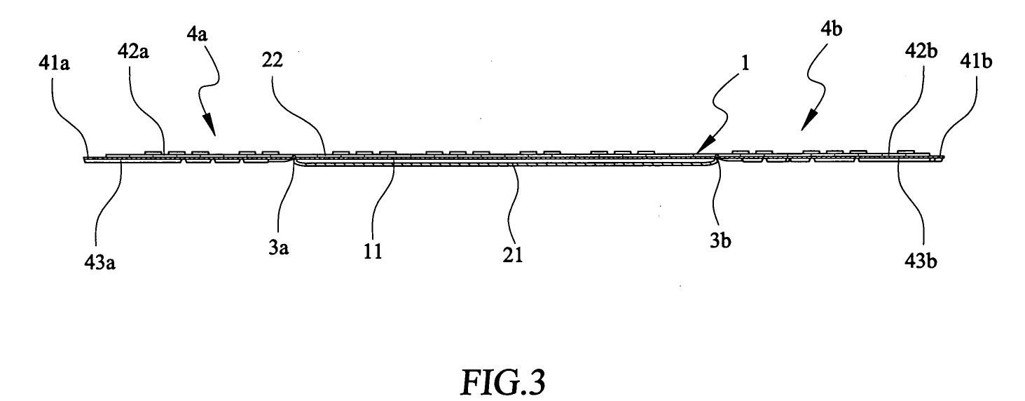

Please refer to FIG. 3 that is a sectional view taken along line 3-3 of FIG. 2. As shown, the integrated computer and music keyboard module 1 of the present invention includes a key assembled base 11, a first or upper side of which has a plurality of parallelly arranged music keys 12 provided thereon, and a second or lower side of which is fixed to the computer case 21 at a position at where a standard keyboard is normally located.

The key assembled base 11 is provided at two lateral ends with a connecting member 3a, 3b each for connecting two extended modules 4a, 4b to the two lateral ends of the key assembled base 11. The extended module 4a includes an extended key assembled base 41a, a first or upper side of which has a plurality of parallelly arranged music keys 42a, and a second or lower side of which has a plurality of computer keys 43a. Similarly, the extended module 4b includes an extended key assembled base 41b, a first or upper side of which has a plurality of parallelly arranged music keys 42b, and a second or lower side of which has a plurality of computer keys 43b.

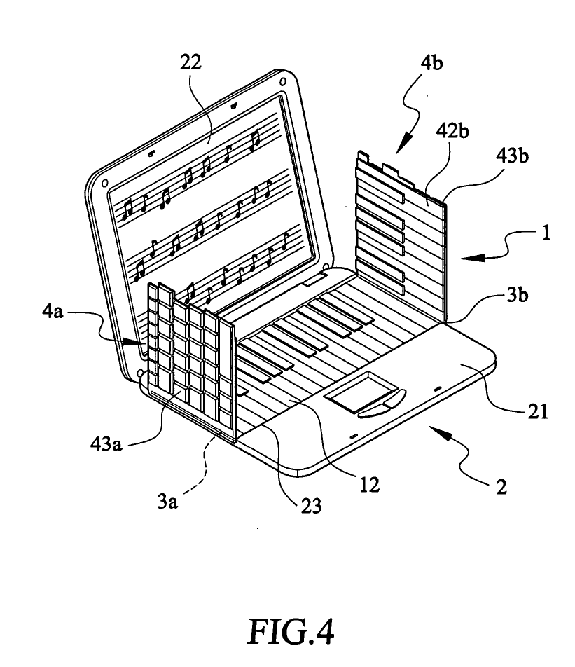

In a preferred embodiment of the present invention, the extended modules 4a, 4b may be folded to lie on two lateral halves of the upper side of the key assembled base 11 by upward turning the extended modules 4a, 4b about the connecting members 3a, 3b, respectively, as shown in FIG. 4.

When the two extended modules 4a, 4b are folded to lie on the upper side of the key assembled base 11, the computer keys 43a, 43b provided on the lower sides of the extended key assembled bases 41a, 41b of the extended modules 4a, 4b, respectively, together make up a standard computer keyboard, as shown in FIG. 1. A user may execute various input functions, such as entering numerics and characters, on the notebook computer 2 via the computer keyboard of the integrated computer and music keyboard module 1.

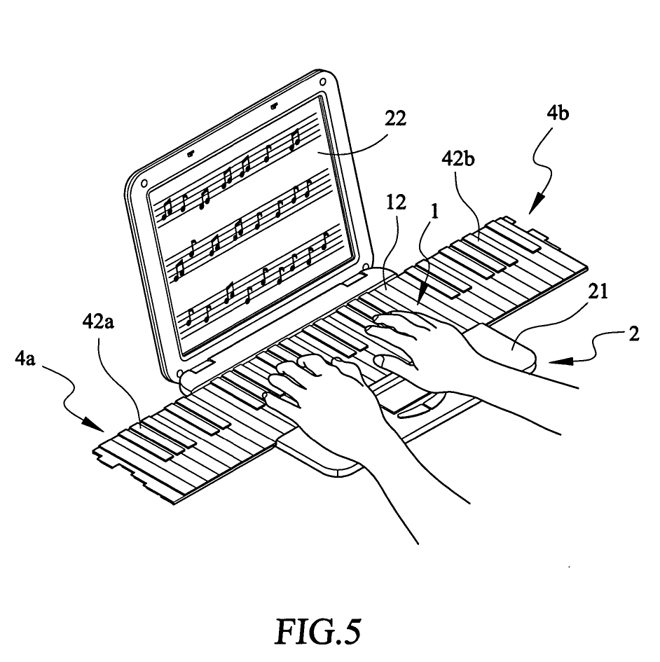

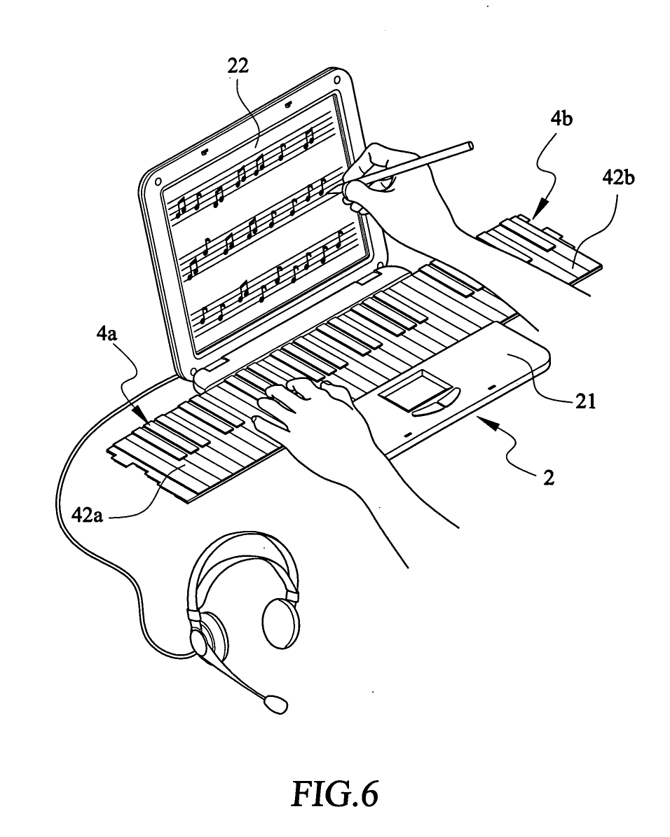

On the other hand, when the two extended modules 4a, 4b at the two lateral ends of the key assembled base 11 are outward turned about the connecting members 3a, 3b to an extended position, the music keys 12 on the upper side of the key assembled base 11 and the music keys 42a, 42b on the upper sides of the extended key assembled bases 41a, 41b are exposed to together make up a music keyboard, as shown in FIG. 2. At this point, a user may play music by operating the music keyboard and using relevant multimedia programs installed on the notebook computer 2 as well as musical notes shown on the display screen 22, as shown in FIG. 5. Or, the user may compose music on the display screen 22 or listen music on the computer 2 by operating the music keyboard and using relevant music composing applications, as shown in FIG. 6.

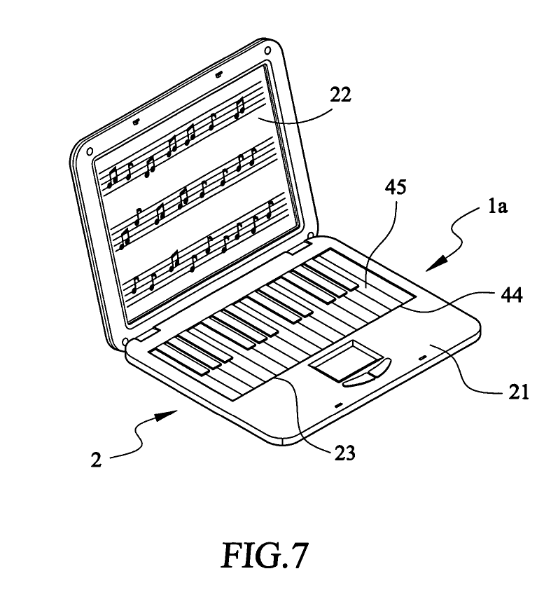

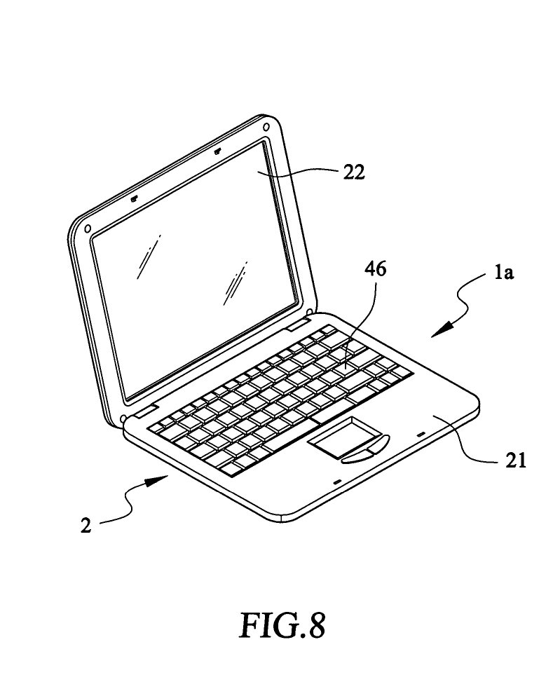

FIGS. 7 and 8 shows an integrated computer and music keyboard module 1a according to a second embodiment of the present invention. Unlike the first embodiment, the keyboard module 1a is non-foldable. The keyboard module 1a includes key assembled base 44, a first or upper side of which is provided with a plurality of parallelly arranged music keys 45, as shown in FIG. 7, and a second or lower side of which is provided with a plurality of computer keys 46, as shown in FIG. 8.

When the integrated computer and music keyboard module 1a is fitted on the computer case 21 of the notebook computer 2 with the first or upper side of the key assembled base 44 facing upward, as shown in FIG. 7, a user may execute the function of playing or composing music on the computer 2 through operating the music keys 45 and using relevant multimedia programs installed on the computer 2 as well as musical notes shown on the display screen 22.

On the other hand, when the integrated computer and music keyboard module 1a is fitted on the computer case 21 of the notebook computer 2 with the second or lower side of the key assembled base 44 facing upward, as shown in FIG. 8, a user may execute various input functions, such as entering numerics and characters, on the notebook computer 2 via the computer keys 46 just like on a general standard computer keyboard.

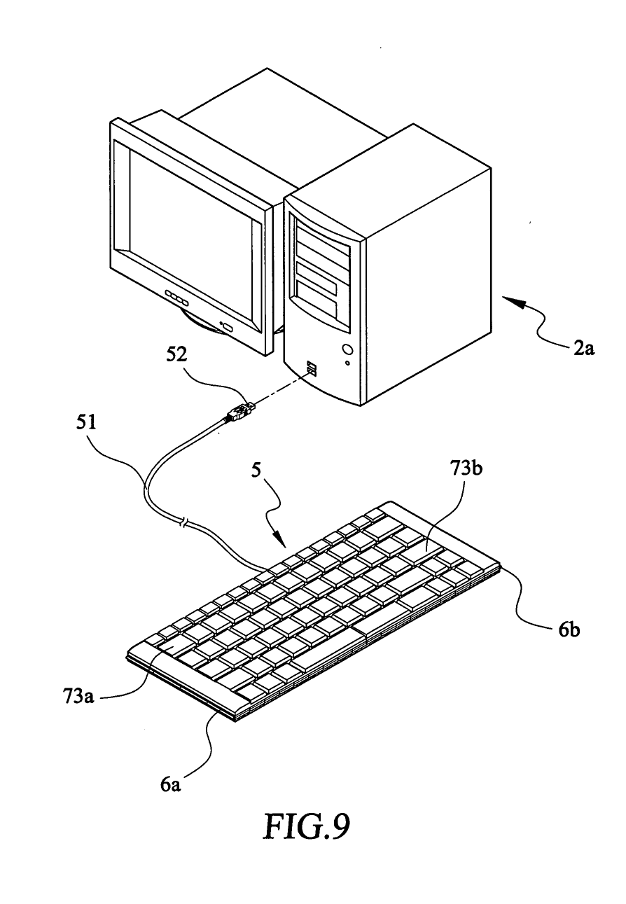

FIG. 9 is a perspective view showing an integrated computer and music keyboard module 5 according to a third embodiment of the present invention. The integrated computer and music keyboard module 5 is a separate module connected to a general notebook computer or a desktop computer 2a via a cable 51 having a connector 52 provided at an end thereof. The connector 52 may be a conventional PS/2 connector or a USB connector.

Alternatively, the integrated computer and music keyboard module 5 may be designed for wirelessly transmitting signals to the computer 2a via infrared ray or radio frequency (RF). And, the computer keys and the music keys on the keyboard module 5 may be traditional mechanical keys or membrane keys.

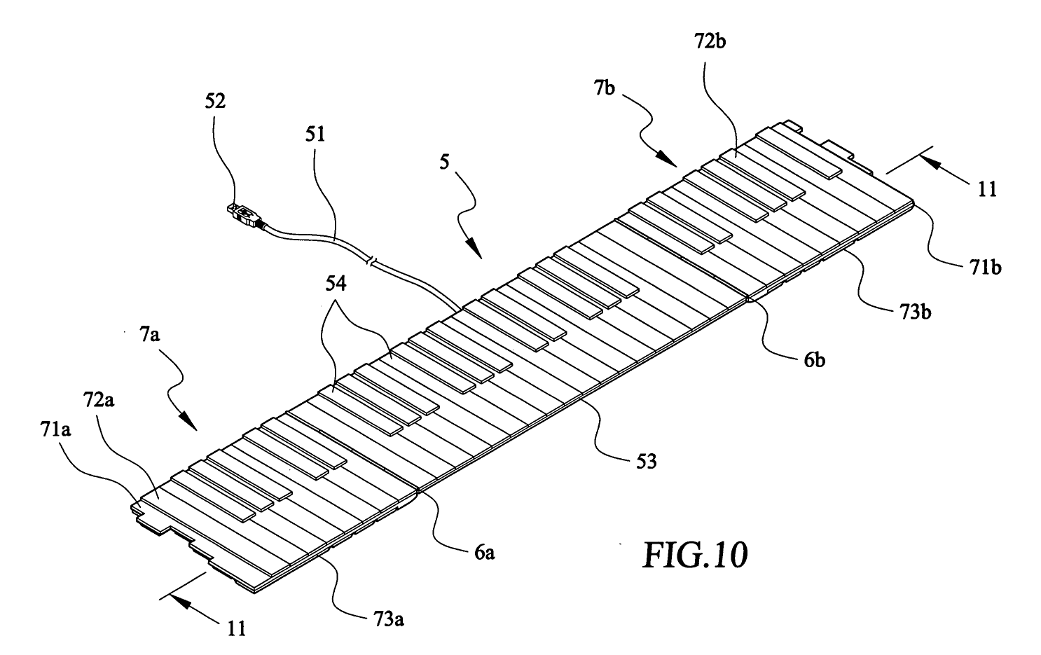

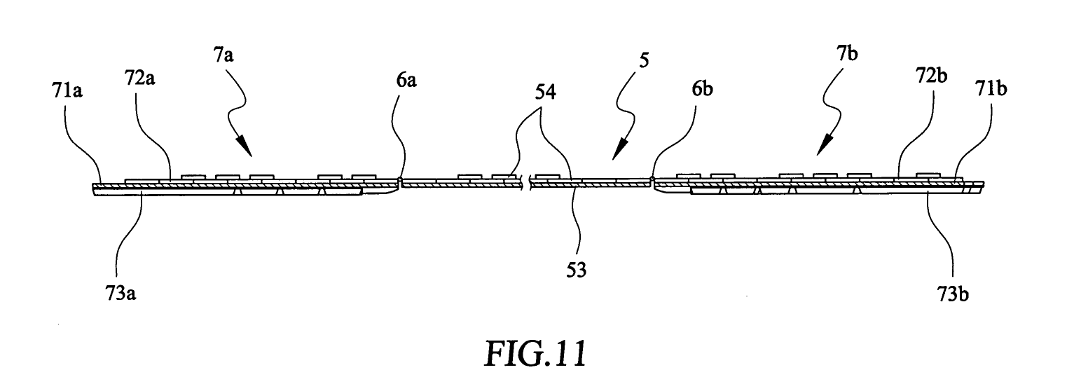

Please refer to FIG. 10 that is a perspective view of the integrated computer and music keyboard module 5 of FIG. 9 in an extended state, and to FIG. 11 that is a sectional view taken along line 11-11 of FIG. 10. As shown, the integrated computer and music keyboard module 5 according to the third embodiment of the present invention includes a key assembled base 53, a first or upper side of which has a plurality of parallelly arranged music keys 54, and a second or lower side of which is designed for laying on a desk top.

The key assembled base 53 is provided at two lateral ends with a connecting member 6a, 6b each for connecting two extended modules 7a, 7b to the two lateral ends of the key assembled base 53. The extended module 7a includes an extended key assembled base 71a, a first or upper side of which has a plurality of parallelly arranged music keys 72a, and a second or lower side of which has a plurality of computer keys 73a. Similarly, the extended module 7b includes an extended key assembled base 71b, a first or upper side of which has a plurality of parallelly arranged music keys 72b, and a second or lower side of which has a plurality of computer keys 73b.

In a preferred embodiment of the present invention, the extended modules 7a, 7b may be folded to lie on two lateral halves of the upper side of the key assembled base 53 by upward turning the extended modules 7a, 7b about the connecting members 6a, 6b, respectively.

When the two extended modules 7a, 7b are folded to lie on the upper side of the key assembled base 53, the computer keys 73a, 73b provided on the lower sides of the extended key assembled bases 71a, 71b of the extended modules 7a, 7b, respectively, together make up a standard computer keyboard, as shown in FIG. 9. A user may execute various input functions, such as entering numerics and characters, on the computer 2a via the computer keyboard of the integrated computer and music keyboard module 5.

On the other hand, when the two extended modules 7a, 7b at the two lateral ends of the key assembled base 53 are outward turned about the connecting members 6a, 6b to an extended position, the music keys 54 on the upper side of the key assembled base 53 and the music keys 72a, 72b on the upper sides of the extended key assembled bases 71a, 71b are exposed to together make up a music keyboard, as shown in FIG. 10.

The present invention has been described with some preferred embodiments thereof used with a notebook or a desktop computer, and it is understood that the present invention may be otherwise used with other digital apparatus, such as palmtop computers, personal digital assistants (PDA), and other communicating apparatus, and that many changes and modifications in the described embodiments can be carried out without departing from the scope and the spirit of the invention that is intended to be limited only by the appended claims.

What is claimed is:

1. An integrated computer and music keyboard module connected to a computer to serve as an input device of the computer, comprising:
a key assembled base having a first and a second side;
a plurality of music keys parallelly arranged on the first side of the key assembled base; and
a plurality of computer keys arranged on the second side of the key assembled base, serving as a computer keyboard of the computer.

2. The integrated computer and music keyboard module as claimed in claim 1, wherein the computer is a notebook computer, and wherein the key assembled base is fitted on a computer case of the notebook computer.

3. The integrated computer and music keyboard module as claimed in claim 1, further comprising a cable having a connector provided thereon for connecting the integrated computer and music keyboard module to the computer.

4. An integrated computer and music keyboard module connected to a computer to serve as an input device of the computer, comprising:
a key assembled base having a first and a second side, the first side of the key assembled base having a plurality of music keys parallelly arranged thereon;
at least one extended module having an extended key assembled base, the extended key assembled base having a first and a second side, the first side having a plurality of music keys arranged thereon, and the second side having a plurality of computer keys arranged thereon; and
at least one connecting member for connecting the extended module to a lateral end of the key assembled base.

5. The integrated computer and music keyboard module as claimed in claim 4, wherein the computer is a notebook computer, and wherein the second side of the key assembled base is fixedly fitted on a computer case of the notebook computer.

6. The integrated computer and music keyboard module as claimed in claim 4, further comprising a cable having a connector provided thereon for connecting the integrated computer and music keyboard module to the computer.

7. The integrated computer and music keyboard module as claimed in claim 4, wherein the connecting member is a foldable connecting member, about which the extended module is turnable to an extended position for operation or to a folded position for lying on the first side of the key assembled base.

8. A digital system, comprising:
a digital apparatus provided with a case and a display screen;
a recess formed on the computer case of the digital apparatus;
an integrated computer and music keyboard module with a key assembled base mounted on the recess, the key assembled base having a first and a second side;
a plurality of music keys parallelly arranged on the first side of the key assembled base; and
a plurality of computer keys arranged on the second side of the key assembled base.

9. The digital system as claimed in claim 8, wherein the digital apparatus is a notebook computer.

10. The digital system as claimed in claim 8, wherein the digital apparatus is a palmtop computer.

11. The digital system as claimed in claim 8, wherein the digital apparatus is a personal digital assistant.

12. The digital system as claimed in claim 8, wherein the digital apparatus is a communicating apparatus.
